(19) United States
(12) Patent Application Publication
(10) Pub. No.: US 2018/0147743 A1
(43) Pub. Date: May 31, 2018

(54) CONCRETE IMPRESSION TEMPLATE

(71) Applicant: John Alguire, Ooltewah, TN (US)

(72) Inventor: John Alguire, Ooltewah, TN (US)

(21) Appl. No.: 15/363,296

(22) Filed: Nov. 29, 2016

(51) Int. Cl. B28B 7/00; B28B 11/10; B28B 11/00; B28B 7/34

(52) U.S. Cl. CPC B28B 7/007; B28B 7/348; B28B 11/001; B28B 11/10

(57) ABSTRACT

A concrete impression template is provided. The template includes a plate having an upper surface, a lower surface and an edge. The lower surface and the upper surface may each be substantially planar. The edge and the lower surface may form a design shaped.

### BACKGROUND OF THE INVENTION

The present invention relates to concrete and, more particularly, to a concrete design template.

Concrete is a composite material composed of coarse aggregate bonded together with a fluid cement which hardens over time. Currently, leaving designs in concrete is performed using tradition stamping. Traditional stamping is limited to size of the pour and only creates textured finishes. Concrete stamping does not leave a detailed design within the concrete.

As can be seen, there is a need for an improved device for leaving designs in concrete.

### SUMMARY OF THE INVENTION

In one aspect of the present invention, a method of forming an impression in a concrete surface comprises the steps of: providing a template comprising a plate comprising an upper surface, a lower surface and an edge, wherein the lower surface is substantially planar and the plate comprises a leaf shape; and placing the lower surface of the template on a concrete surface that is curing.

In another aspect of the present invention, a method of forming an impression in a concrete surface comprises the steps of: providing a plastic template comprising a plate comprising an upper surface, a lower surface and an edge, wherein at least one of the lower surface and the edge forms a design shape; placing the lower surface of the template on a concrete surface that is curing after bleed water is absorbed and evaporated from the concrete surface; applying pressure against the template into the concrete surface; and removing the template from the concrete surface once the concrete surface is dry.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention illustrating a concrete surface with an impression;

FIG. 2 is an exploded view of an embodiment of the present invention illustrating the template removed from the concrete surface;

FIG. 3 is a perspective view of an embodiment of the present invention;

FIG. 4 is a top view of an embodiment of the present invention;

FIG. 5 is a bottom view of an embodiment of the present invention;

FIG. 6 is an exploded section view of an embodiment of the present invention;

FIG. 7 is a detail section view illustrating a template within an impression; and

FIG. 8 is a detail section view illustrating a template removed from an impression.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a thin reusable and disposable plastic concrete impression template that is left in during finishing and curing of concrete and cement materials. The present invention provides templates in many different designs that give a clear impression.

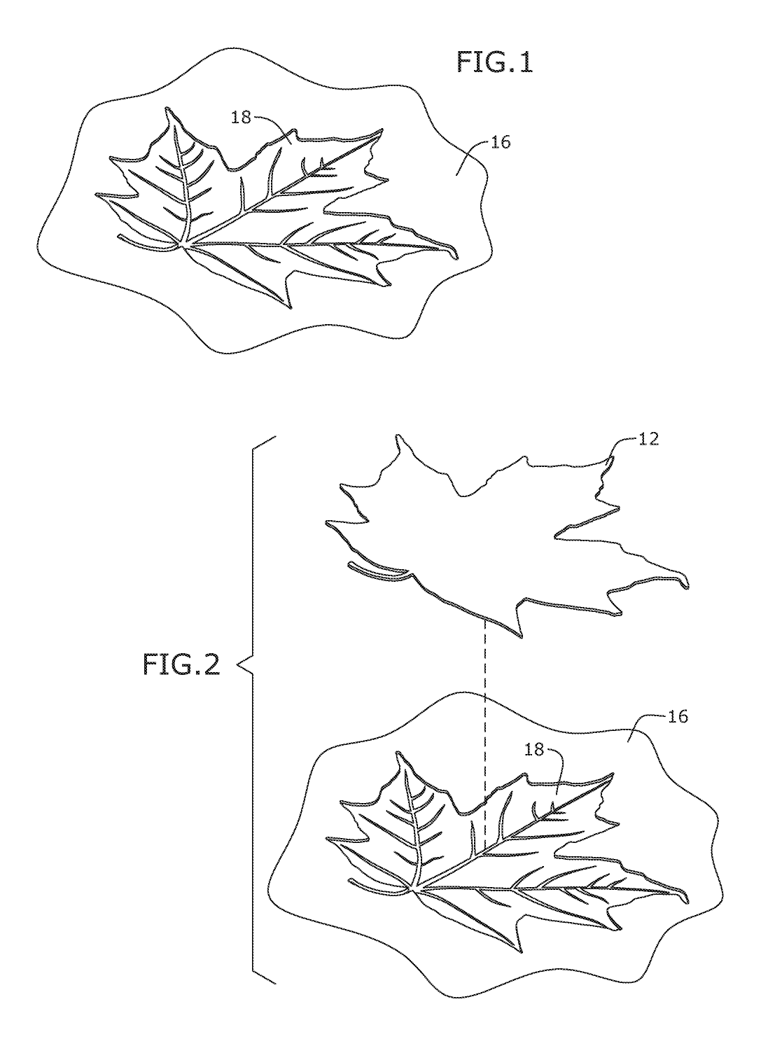

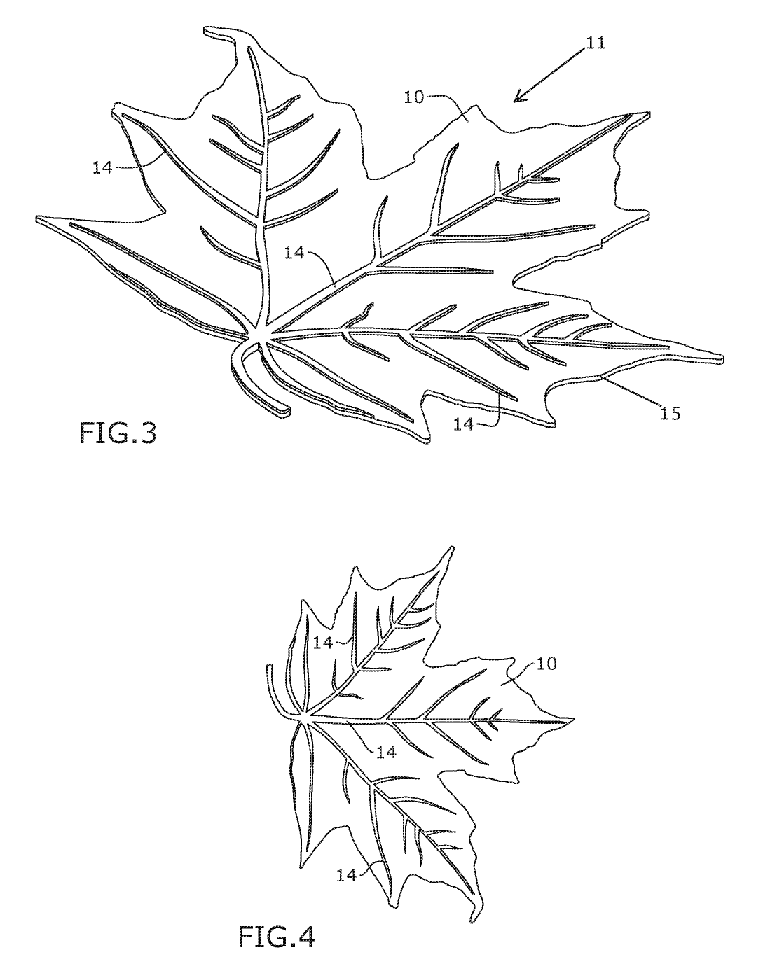

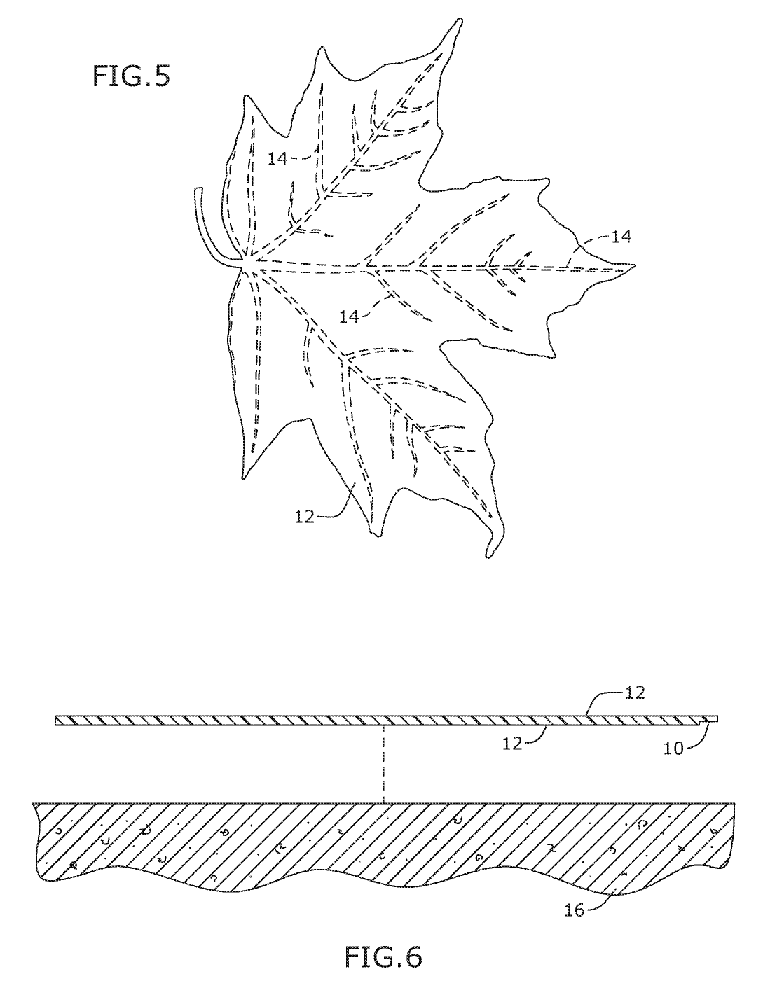

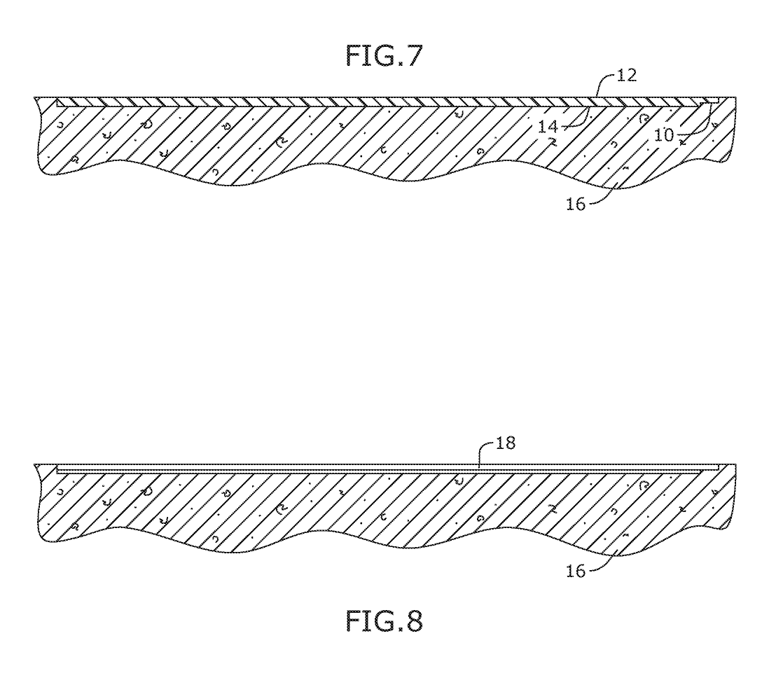

Referring to FIGS. 1 through 8, the present invention includes a concrete impression template. The template includes a plate 11 having an upper surface 12, a lower surface 10 and an edge 15. The lower surface 10 and the upper surface 12 may each be substantially planar. The edge 15 and the lower surface 12 may form a design shaped. For example, as illustrated in the Figures, the edge 15 forms a leaf shape. In such embodiments, the lower surface 12 may include a raised portion 14 forming elongated strands forming a leaf vein shape.

A method of forming an impression 18 on a concrete surface 16 may include the following. A user places the lower surface 10 of the template on the concrete surface 16 that is curing after bleed water is evaporated and absorbed from the concrete surface 16. Pressure is applied against the upper surface 12 of the template into the concrete surface 16. The concrete surface 16 is then allowed to dry, which may take up to 24 hours. The template is then removed from the concrete surface 16, leaving the impression 18. Alternatively, the plate 11 may be made of a biodegradable material. In such embodiments, the template may be left in the impression 18 and biodegrade. Using the present invention, the user may beautify and customize concrete with logos, monograms, detailed patterns and the like.

The plate 11 of the present invention may be made of a rigid or stretchable and bendable polymer. In certain embodiments, the plate 11 may be made of a translucent polymer. The polymer may be a plastic. Alternatively, the polymer may be a biodegradable translucent polymer, which may be left in the impression 18 and biodegrade. The present invention may be made by a 3D printer. The present invention may also be made using a plastic mold injection process.

It should be understood, of course, that the foregoing relates to exemplary embodiments of the invention and that modifications may be made without departing from the spirit and scope of the invention as set forth in the following claims.

What is claimed is:

1. A method of forming an impression in a concrete surface comprising the steps of:
providing a template comprising a plate comprising an upper surface, a lower surface and an edge, wherein the lower surface is substantially planar and the edge forms a leaf shape; and
placing the lower surface of the template on a concrete surface that is curing.

2. The method of claim 1, wherein the lower surface of the template is placed on the concrete surface after bleed water is evaporated and absorbed from the concrete surface.

3. The method of claim 1, further comprising the step of:
applying pressure against the template into the concrete surface.

4. The method of claim 1, further comprising the step of:
removing the template from the concrete surface once the concrete surface is dry.

5. The method of claim 1, wherein the lower surface comprises a raised portion comprising elongated strands forming a leaf vein shape.

6. The method of claim 1, wherein the upper surface is substantially planar.

7. The method of claim 1, wherein the template is formed of a translucent material.

8. The method of claim 5, wherein the translucent material is a translucent polymer.

9. A method of forming an impression in a concrete surface comprising the steps of:
providing a plastic template comprising a plate comprising an upper surface, a lower surface and an edge, wherein at least one of the lower surface and the edge forms a design shape;
placing the lower surface of the template on a concrete surface that is curing after bleed water is absorbed and evaporated from the concrete surface;
applying pressure against the template into the concrete surface; and
removing the template from the concrete surface once the concrete surface is dry.

10. The method of claim 9 wherein the plastic template is a translucent polymer.
